(19) United States
(12) Patent Application Publication
(10) Pub. No.: US 2019/0002656 A1
(43) Pub. Date: Jan. 3, 2019

(54) Anti-Scalping Pharmaceutical Packaging Film

(71) Applicant: Bemis Company, Inc., Neenah, WI (US)

(72) Inventors: Yuan Liu, Neenah, WI (US); Rishabh Jain, Appleton, WI (US); Micheal D. Priscal, Neenah, WI (US)

(21) Appl. No.: 15/748,692

(22) PCT Filed: Aug. 26, 2015
(86) PCT No.: PCT/US15/46974

§ 371 Date: Jan. 30, 2018

(51) Int. Cl. C08J 5/18; B32B 7/12; B32B 15/08; B32B 27/08; B32B 27/30; B32B 27/32

(52) U.S. Cl. CPC C08J 5/18; B32B 7/12; B32B 15/08; B32B 27/08; B32B 27/304; B32B 27/322; C08J 2327/16; B32B 2307/7244; B32B 2307/7246; B32B 2439/80; B32B 2556/00; C08J 2327/04; B32B 2307/31

(57) ABSTRACT

A film for packaging a pharmaceutical active agent-containing product includes a product-contacting sealing layer that does not scalp the pharmaceutical active product. The product contacting layer includes at least 90 wt. % of a CTFE-VDF copolymer. The pharmaceutical active agent can be nicotine. The product can be a transdermal patch.

### FIELD

The present application relates generally to packaging suitable for packaging an article for collecting or administering a physiologically active substance such as transdermal drug delivery patches.

### TECHNICAL BACKGROUND

Pharmaceuticals such as the drugs fentanyl and nicotine are often administered through the use of transdermal patches which are applied to a patient's skin to permit drug delivery over time by absorption. Prior to application of a drug containing patch, the patch is packaged in a pouch which is designed to be opened to permit access to the patch by the patient or caregiver for application to a patient's skin. Suitable packaging for transdermal patches should contain the patch and its drug within the package while protecting the patch from contamination and deleterious effects from the external environment. Thus, articles such as a pouch may hold a transdermal patch to protect the patch and its drug contents from contact or exposure to unwanted materials such as microbes, insects, air, moisture, sunlight, etc. The container is typically sealed e.g. by a heat seal to provide a hermetic barrier.

The materials used in constructing transdermal patch packaging and especially the patch contact package interior surface layer should resist migration of chemicals between the patch and the package materials. Such migration of the drug or patch components from the patch to the package structure is referred to as “scalping”. A common material employed for transdermal patch package interior surface layers that prevents scalping is polyacrylonitrile which is often sold under the Barex® trademark by Ineos AG. While Barex® has superb antiscalping properties it is very expensive, has poor tear properties that make pouch opening difficult, and has limited availability which creates supply chain risk. Other polymers used in transdermal patch packaging as a surface contact layer include polyester. Polyester suffers from the disadvantage of being less resistant to scalping of certain chemicals than desired and its tear properties are also less than desired. Accordingly, there is a need for a more cost efficient packaging material for containing articles for collecting or administering a physiologically active substance such as transdermal drug delivery patches.

Fluoropolymers could potentially be suitable for contact with pharmacological or physiological substances because fluoropolymers such as poly(chlorotrifluoroethylene) (PCTFE) and polyvinylidine fluoride (PVDF) are considered to be chemically resistant. However, fluoropolymers, while being relatively chemically inert, may not serve as effective barriers for resisting migration of physiologically active substances. For example, U.S. Pat. No. 5,268,209 states that PVDF and chlorotrifluoroethylene (CTFE) are ineffective nicotine barriers. In particular, U.S. Pat. No. 5,268,209 illustrates that PVDF allows considerably more migration of nicotine than Barex®.

### BRIEF SUMMARY

This disclosure, among other things, relates to films for packaging products containing a pharmaceutical active agent. The films resist migration of chemicals, such as pharmacological active agents or excipients, between the product and the film. Thus, the films are anti-scalping films.

The product-contacting layers of the films described herein include a copolymer comprising chlorotrifluoroethyl units and 1,1 difluoroethyl units (referred to hereinafter as a “CTFE-VDF copolymer”). CTFE-VDF copolymers may be formed by, for example, copolymerizing CTFE and vinylidine fluoride (VDF) monomers. CTFE-VDF copolymer layers are shown herein to resist migration of nicotine. Because CTFE and PVDF were previously determined to be ineffective nicotine barriers (see U.S. Pat. No. 5,286,209), effective resistance to nicotine migration by a CTFE-VDF copolymer as described herein was unexpected.

Product-contacting CTFE-VDF copolymer layers are described herein to also have effective antiscalping properties with regard to lidocaine and acetylfentanyl.

It is believed that the CFTE-VDF copolymers described herein may also be anti-scalping with regard to other pharmacological agents. By way of example, CFTE-VDF copolymers described herein can be used as product contacting layers when the product includes one or more of nicotine, fentanyl, estradiol, clonidine, ethinyl estradiol, oxybutynin, buprenorphine, granisetron, methylphenidate, and scopolamine or when one or more of these agents are associated with a volatile carrier.

In various embodiments, a CTFE-VDF copolymer described herein comprises from about 0.1 mol % to about 20 mol % 1,1-difluoroethyl units.

Preferably, the product-contacting copolymer layers are sealing layers.

In various embodiments described herein, a film for packaging a nicotine-containing product includes a product-contacting sealing layer comprising at least 90 wt. % of a chlorotrifluoroethylene (CTFE)-vinylidene fluoride (VDF) copolymer.

In various embodiments described herein, a film for packaging a pharmaceutical active agent-containing product includes a product-contacting sealing layer comprising at least 90 wt. % of a chlorotrifluoroethylene (CTFE)-vinylidene fluoride (VDF) copolymer. The pharmaceutical active agent can be, for example, one or more of fentanyl, lidocaine, estradiol, clonidine, ethinyl estradiol, oxybutynin, buprenorphine, granisetron, methylphenidate, and scopolamine.

In some embodiments, a CTFE-VDF copolymer comprises at least 80 mol % chlorotrifluoroethyl units and at least 1 mol % 1,1-dilfuoroethyl units.

In some embodiments, a CFTE-VDF copolymer of a film described herein has a glass transition temperature in a range from 40° C. to 70° C.

In some embodiments, the product-contacting sealing layer of a film described herein comprises at least 95 wt. % of the CTFE-VDF copolymer or consists essentially of the CTFE-VDF copolymer.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic cross-sectional view of a multilayer film in accordance with embodiments presented herein; and

FIG. 2 is a schematic cross-sectional view of a multilayer film in accordance with embodiments presented herein; and

FIG. 3 is a schematic view of a packaged product in accordance with embodiments presented herein.

The schematic drawings are not necessarily to scale. Like numbers used in the figures refer to like components. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### DETAILED DESCRIPTION

Reference will now be made in greater detail to various embodiments of the subject matter of the present disclosure, some embodiments of which are illustrated in the accompanying drawings.

The present disclosure relates to, among other things, films for packaging products containing a pharmaceutical active agent. The films resist migration of chemicals, such as pharmacological active agents or excipients, between the product and the film. Thus, the films are anti-scalping films. In a packaged product, the anti-scalping layer can be in contact with the pharmaceutical active agent. As used herein, “in contact with the pharmaceutical active agent,” in the context of a layer of a film, means that under typical storage conditions some portion of the active agent will contact the layer. The active agent may be in direct contact with the product contacting layer or may be in indirect contact with the layer. Indirect contact between the active agent and the product contacting layer can occur, for example, due to volatilization of the active agent or an active agent carrier within the package to cause the active agent, which is not stored in direct contact with the product contacting layer, to contact the layer. However, even if the active agent is not in contact with the sealing layer, it may be desirable for the sealing layer to be anti-scalping to provide assurance that if an active agent accidentally became exposed to the sealing layer, the sealing layer would not substantially scalp the active agent.

### Product Contact Layer

The films described herein have a product contact layer containing a CFTE-VDF copolymer. As used herein a CFTE-VDF copolymer is a polymer that comprises chlorofluoroethyl units and 1,1-difluoroethyl units. For the purposes of the present disclosure a “chlorofluoroethyl unit” is

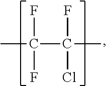

and a 1,1-difluoroethyl unit is

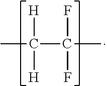

Such CTFE-VDF copolymer layers are shown herein to resist migration of nicotine. Because CTFE and PVDF were previously determined to be ineffective nicotine barriers (see U.S. Pat. No. 5,286,209), effective resistance to nicotine migration by a CTFE-VDF copolymer as described herein was unexpected.

It is believed that the CFTE-VDF copolymers described herein may also be anti-scalping with regard to other pharmacological agents. By way of example, CFTE-VDF copolymers described herein can be used as product contacting layers when the product includes one or more of nicotine, fentanyl, acetylfentanyl, lidocaine, estradiol, clonidine, ethinyl estradiol, oxybutynin, buprenorphine, granisetron, methylphenidate, and scopolamine or when one or more of these agents are associated with a volatile carrier.

In some embodiments, CFTE-VDF copolymers described herein can be used as product contacting layers when the product includes one or more of nicotine, acetylfentanyl, and lidocaine. In addition to resisting migration of nicotine, CTFE-VDF copolymer layers are shown herein to resist migration of acetylfentanyl and lidocaine.

In various embodiments, the CFTE-VDF copolymer of the product-contacting sealing layer comprises at least 80 mol % chlorotrifluoroethyl units and at least 1 mol % 1,1-difluoroethyl units. The CTFE-VDF copolymer can, in some embodiments, comprise from about 80 mol % to about 99.9 mol % chlorotrifluoroethyl units. The CTFE-VDF copolymer can, in some embodiments, comprise from about 1 mol % to about 20 mol % 1,1-difluoroethyl units. In some embodiments, a CTFE-VDF copolymer comprises from about 1 mol % to about 15 mol % 1,1-difluoroethyl units, such as from about 1 mol % to about 10 mol % or from about 1 mol % to about 5 mol %. In some embodiments, a CTFE-VDF copolymer comprises from about 2 mol % to about 4 mol % 1,1-difluoroethyl units. In some embodiments, the CTFE-VDF copolymer consists essentially of, or consists of, chlorotrifluoroethyl units and 1,1-difluoroethyl units.

CTFE-VDF copolymers can be formed in any suitable manner For example, CFTE-VDF copolymer can be formed by copolymerizing CTFE and VDF monomers, in an appropriate molar or weight ratio, can be formed by grafting compounds comprising 1,1-difluoroethyl units to a CTFE polymer, or the like. In some embodiments, the CTFE-VDF copolymers can be made as described in U.S. Patent Application Publication No. 2007/0128393, entitled HEAT SEALABLE PCTFE FILM AND TUBING USING HIGH VF2 CONTAINING COPOLYMERS OF CTFE/VF2, published on Jun. 7, 2007 or U.S. Patent Application Publication No. 2013/0184422, entitled PROCESS, PROPERTIES, AND APPLICATIONS OF GRAFT COPOLYMERS, published on Jul. 18, 2013, which published patent applications are hereby incorporated herein by reference in their respective entireties to the extent that they do not conflict with the disclosure presented herein.

Without intending to be bound by theory, it is believed that increased mole percentages of 1,1-difluoroethyl units in a CTFE-VDF copolymer will increase sealability of the copolymer but will decrease the antiscalping properties of the copolymer. The ranges of mole percent provided above reflect ranges that are believed to provide both suitable sealability, such as heat sealable in a temperature range of from about 300° F. to about 450° F. or about 145° C. to about 235° C., and suitable barrier properties, such as antiscalping properties.

Examples of CTFE-VDF copolymer films that are particularly suitable for use as product-contacting sealing layers in some embodiments include PFX-14-12 (1.5 mil) and PFX 14-13 (3.0 mil) produced by Honeywell International, Inc. (Morristown, N.J.). PFX-14-12 and PFX 14-13 are development numbers.

Any suitable process can be used to seal packaging having product-contacting copolymer layers described herein. For example, the product contacting layers, in some embodiments, can be sealed using ultrasonic sealing techniques as generally known in the art. In some embodiments, one or more strips of a cold sealing coating can be applied to the product-contacting layers. However, the entire product-contacting layer cannot be coated with a cold sealing coating, because the product-contacting layer would not be available for contact with the packaged product. Because the packaged product may contact cold seal material even if the cold seal coating is limited to regions of the seal, cold sealing is generally not preferred. Preferably, the product contacting layers are heat sealed.

Accordingly, the product-contacting copolymer layers described herein are preferably heat sealable. That is, the layers are preferably capable of fusion bonding by conventional indirect heating which generates sufficient heat on at least one film contact surface for conduction to the contiguous film contact surface and formation of a bond interface therebetween without loss of the film integrity. The bond interface between contiguous inner layers preferably has sufficient physical strength to withstand the packaging process and subsequent handling. Advantageously, the bond interface is preferably sufficiently thermally stable to prevent gas or liquid leakage therethrough when exposed to above or below ambient temperatures e.g. during one or more of the following: packaging operations, storage, handling, and transport.

In some embodiments, a CTFE-VDF copolymer of a product-contacting sealing layer has a glass transition temperature of about 100° C. or less, such as about 80° C. or less, or 70° C. or less. The copolymer, in various embodiments, has a glass transition temperature of about 20° C. or more. In some embodiments, the copolymer has a glass transition temperature in a range from about 40° C. to about 70° C., such as from about 50° C. to about 60° C. PFX-14-12 and PFX 14-13, CTFE-VDF copolymer films produced by Honeywell International, Inc. (Morristown, N.J.), have glass transition temperatures of about 55° C.

In some embodiments, a product-contacting layer includes one or more of the following properties: a melting point of about 170° C.; a dimensional stability as determined by ASTM D1240 of +8% or more in the machine direction; a tensile strength as determined by ASTM D882 in the machine direction of from about 60 to about 75 MPa and in the transverse direction of from about 40 to about 50 MPa; and elongation as determined by ASTM D882 in the machine direction of about 150% and in the transverse direction of about 250%; a modulus (secant) as determined by ASTM D882 of from about 1050 to about 1200 MPa in the machine direction and from about 1000 to about 1150 MPa in the transverse direction; and a water vapor transmission rate (WVTR) as determined by ASTM F1249 of from about 0.01 to about 0.04 g/100 square inches per 24 hours are 37.8° C., 100% relative humidity, and one atmosphere.

It will be understood that some of the aforementioned properties can be affected by the thickness of the product-contacting layer, which can be of any suitable thickness. For example, the thickness of a product-contacting layer may advantageously be less than about 0.45 mil (10.16 microns) and greater than about 0.05 mil (1.27 microns), including 0.10, 0.15, 0.20, 0.25, 0.30, 0.40, or 0.45 mil thick.

In various embodiments, the product-contacting layer comprises at least 90 wt. % of a CTFE-VDF copolymer, more preferably at least 95 wt. %, and most preferably about 100 wt. %. A CTFE-VDF copolymer be blended with up to 10 wt. %, preferably up to 5 wt. % and more preferably up to 2.5 wt. % of compatible polymers, colorants, processing aids and the like. Use of these polymers and components in a blend with the CTFE-VDF copolymer may undesirable affect the anti-scalping properties of this layer and addition of amounts above 10 wt. % may be unacceptable for many applications of the film for packaging drugs or drug articles such as transdermal patches e.g. nicotine patches or fentanyl patches.

Films and packaging described herein may include one or more additional optional layers, such as one or more barrier layers, an outer layer which can be an abuse-resistant outer layer, one or more intermediate layers, which may include one or more tie layers.

### Barrier Layer

If included, a barrier layer preferably functions both as a gas barrier layer, and as a moisture barrier layer, although these functions may be provided by separate layers. A gas barrier layer is preferably an oxygen barrier layer, and is preferably a core layer positioned between and protected by surface layers. For example, an oxygen barrier layer can be in contact with a first surface layer and an adhesive layer or may be sandwiched between two tie layers and/or two surface layers.

An oxygen barrier is preferably selected to provide an oxygen permeability sufficiently diminished to protect the packaged article from undesirable deterioration or oxidative processes. For example, a film may comprise an oxygen barrier having an oxygen permeability that is low enough to prevent oxidation of oxygen sensitive articles and substances to be packaged in the film e.g. oxygen sensitive articles such as transdermal patches e.g. nicotine or fentanyl patches or oxygen sensitive collection samples such as blood which may be collected e.g. in a microcassette device. Preferably a multilayer packaging film in accordance with the present invention will have an oxygen barrier of less than or equal to 10 cm³/100 inches²/24 hours at 1 atmosphere and 23° C., more preferably less than 0.016 cm³/m² per 24 hours at 1 atmosphere. To protect oxygen sensitive articles from deterioration from oxygen contact over time the films according to the present invention will have a preferred oxygen transmission rate (O₂TR) of less than 1, preferably less than 0.1, more preferably less than 0.01, and most preferably less than 0.001 g/100 inches² at 24 hours at Room Temperature(RT) (˜23° C.) and 1 atmosphere (<0.001 g/m² at 24 hours at Room Temperature (RT) (˜23° C.)) and 1 atmosphere).

A moisture barrier is preferably selected to provide a moisture permeability sufficiently diminished to protect the packaged article from undesirable deterioration. For example, a film may comprise a water barrier having a moisture permeability that is low enough to prevent deleterious effects upon packaged articles such as transdermal drug patches or other moisture sensitive products. A preferred film according to various embodiments will have a water or moisture transmission rate (WVTR) of less than 0.01 g/100 inches² per 24 hours at Room Temperature (RT) (23° C.) and 1 atmosphere. In some embodiments, a film has a WVTR of less than 0.01 g/100 inches² per 24 hours at Room Temperature (RT) (23° C.) and 1 atmosphere, or less than 0.001 g/100 inches² per 24 hours at Room Temperature (RT) (23° C.) and 1 atmosphere.

A barrier layer can comprise any suitable material. An oxygen barrier layer can comprise EVOH, polyvinylidene chloride, polyamide, polyester, polyalkylene carbonate, polyacrylonitrile, nanocomposite, a metallized film such as aluminum vapor deposited on a polyolefin, etc., as known to those of skill in the art. Suitable moisture barrier layers include aluminum foil, PVDC, or polyolefins such as LDPE or LLDPE. It is desirable that the thickness of the barrier layer be selected to provide the desired combination of the performance properties sought e.g. with respect to oxygen permeability, and delamination resistance, and water barrier properties. Suitable thicknesses in multilayer films are less than 15%, e.g. from 3 to 13% of the total film thickness and preferably less than about 10% of the total thickness of the multilayer film. Greater thicknesses may be employed however oxygen barrier polymers tend to be relatively expensive and therefore it is expected that less costly resins will be used in other layers to impart desirable properties once a suitable thickness is used to achieve the desired gas barrier property for the film layer combination. For example, the thickness of a core oxygen barrier layer may advantageously be less than about 0.45 mil (10.16 microns) and greater than about 0.05 mil (1.27 microns), including 0.1 0, 0.20, 0.25, 0.30, 0.40, or 0.45 mil thick.

An oxygen barrier layer of a film may comprise a metal or metal oxide layer, or EVOH, although oxygen barrier layers comprising polyvinylidene chloride-vinyl chloride copolymer (PVDC or VDC-VC) or vinylidene chloride-methylacrylate copolymer (VDC-MA) as well as blends thereof, can also be used. One suitable EVOH barrier material is a 44 mol % EVOH resin E151B sold by Eval Company of America, under the trade name EVAL® LC-E151B. Another example of an EVOH that may be acceptable can be purchased from Nippon Gohsei under the trade name Soarnol® AT (44 mol % ethylene EVOH).

Any suitable metal or metal oxide layer can be used as a barrier layer. Examples of suitable metal and metal oxide layers include foils and deposited metals, such as aluminum foil, aluminum oxide, silicon oxide, metalized polyethylene terephthalate, and the like.

For packaging of oxygen sensitive articles such as drug patches, an oxygen (O₂) permeability of less than about 310 cm³/m² for a 24 hour period at 1 atmosphere, 0% relative humidity and 23° C., and preferably less than 75 cm³/m², more preferably less than 20 cm³/m². The thickness of the core layer may be varied and beneficially may be from about 0.05 to about 0.60 mils (1.3-15.2 microns).

A bulk layer may be provided to provide additional functionality such as stiffness or heat sealability or to improve machinability, cost, flexibility, barrier properties, etc. Preferred bulk layers comprise one or more polyolefins such as polyethylene, ethylene-alpha olefin copolymers (EAO), polypropylene, polybutene, ethylene copolymers having a majority amount by weight of ethylene polymerized with a lesser amount of a comonomer such as vinyl acetate, and other polymeric resins falling in the “olefin” family classification. The bulk layer may be of any suitable thickness from 0.1 to 7 mils or may even be omitted for use in certain applications, but is preferably present to improve especially stiffness/flexibility properties and heat sealability.

### Exterior Protective Layer

The films described herein may include an exterior layer. Since it is seen by the user/consumer, in both monolayer and multilayer embodiments, the exterior surface of the film preferably has desirable optical properties and may preferably have high gloss. Also, it preferably withstands contact with sharp objects and provides abrasion resistance, and for these reasons it is often termed the abuse resistant or protective layer. This exterior protective layer may or may not also be used as a heat sealable layer. As the exterior surface layer of the film, this layer most often is also the exterior layer of any package, bag, pouch or other container made from a film described herein, and is therefore subject to handling and abuse e.g. from equipment during packaging, and from rubbing against other packages and shipping containers and storage shelves during transport and storage. This contact causes abrasive forces, stresses and pressures which may abrade away the film causing defects to printing, diminished optical characteristics or even punctures or breaches in the integrity of the package. Therefore the exterior surface layer is typically made from materials chosen to be resistant to abrasive and puncture forces and other stresses and abuse which the packaging may encounter during use. The exterior surface layer should be easy to machine (i.e. be easy to feed through and be manipulated by machines e.g. for conveying, packaging, printing or as part of the film or bag manufacturing process). Suitable stiffness, flexibility, flex crack resistance, modulus, tensile strength, coefficient of friction, printability, and optical properties are also frequently designed into exterior layers by suitable choice of materials. This layer may also be chosen to have characteristics suitable for creating desired heat seals which may be heat resistance to burn through e.g. by impulse sealers or may be used as a heat sealing surface in certain package embodiments e.g. using overlap seals. The exterior layer may be tough to impart resistance to opening by children e.g. preventing the package from being opened by a child's bite. A preferred exterior child resistant layer comprise polyester film, preferably polyester terephthalate, preferably at least 0.9 mil in thickness. Suitable exterior surface layers may comprise: paper, oriented polyester, amorphous polyester, polyamide, polyolefin, cast or oriented nylon, polypropylene, or copolymers, or blends thereof. Oriented films of this or any other layer may be either uni-axially or bi-axially oriented. The exterior layer thickness is typically 0.5 to 2.0 mils. Thinner layers may be less effective for abuse resistance, however thicker layers, though more expensive, may advantageously be used to produce films having unique highly desirable puncture resistance and/or abuse resistance properties.

### Intermediate Layer

An intermediate layer is any layer between the exterior layer and the interior layer and may include oxygen barrier layers, tie layers or layers having functional attributes useful for the film structure or its intended uses. Intermediate layers may be used to improve, impart or otherwise modify a multitude of characteristics: e.g. printability for trap printed structures, machinability, tensile properties, flexibility, stiffness, modulus, designed delamination, easy opening features, tear properties, strength, elongation, optical, moisture barrier, oxygen or other gas barrier, radiation selection or barrier e.g. to ultraviolet wavelengths, etc. Suitable intermediate layers may include: adhesives, adhesive polymers, paper, oriented polyester, amorphous polyester, polyamide, polyolefin, nylon, polypropylene, or copolymers, or blends thereof Suitable polyolefins may include: polyethylene, ethylene-alpha olefin copolymers (EAO), polypropylene, polybutene, ethylene copolymers having a majority amount by weight of ethylene polymerized with a lesser amount of a comonomer such as vinyl acetate, and other polymeric resins falling in the “olefin” family classification, LDPE, HDPE, LLDPE, EAO, ionomer, EMA,EAA, modified polyolefins e.g. anhydride grafted ethylene polymers, etc.

### Tie Layer

A multilayer packaging film can include one or more adhesive layers, also known in the art as “tie layers,” which can be selected to promote the adherence of adjacent layers to one another in a multilayer film and prevent undesirable delamination. A multifunctional layer is preferably formulated to aid in the adherence of one layer to another layer without the need of using separate adhesives by virtue of the compatibility of the materials in that layer to the first and second layers. Alternatively, the tie layers can serve as an intermediary to different adhesives that are compatible with different layers or can serve to aid in the adherence of one layer to another layer without the need of using a separate adhesive while serving as an intermediary between a different layer and an adhesive.

In some embodiments, adhesive layers comprise materials found in both the first and second layers that the adhesive layer adheres together. The adhesive layer may suitably be less than 10% and preferably between 2% and 10% of the overall thickness of the multilayer film. Adhesive resins are often more expensive than other polymers so the tie layer thickness is usually kept to a minimum consistent with the desired effect.

A CTFE-VDF copolymer described herein is a fluoropolymer. Fluoropolymers can form non-stick surfaces to which adhesives or other layers may not readily adhere. In some embodiments, a surface of the product-contacting layer is treated to add functionality to the surface to aid in adherence of an adhesive, tie layer or other layer. In some embodiments, the surface is treated to graft functional groups to aid in adherence. Suitable treatments include plasma treatment, such as atmospheric plasma treatment, corona treatment, flame treatment or the like. In some embodiments, a tie layer is formed by blending a polymer of a polymer layer to which the product-contacting layer is to be adhered (via the tie layer) with one or more of polyCTFE, polyVDF, and a CTFE-VDF copolymer. One suitable adhesive for uses with CTFE-VDF copolymer as described herein is Flextra® WD-4067, a water soluble adhesive available from H.B. Fuller (St. Paul, Minn.), with XR-6610 as a coreactant.

In some embodiments, a multilayer film comprises a first adhesive layer positioned between and in direct contact with an exterior layer and a product contacting layer.

In some embodiments, a multilayer film comprises a first adhesive layer positioned between and in direct contact with a product contacting layer and a metal or metal oxide layer. The metal or metal oxide layer can be a foil or deposited layer. The multilayer film further includes a polyolefin layer, such as a polyethylene layer, in contact with the metal or metal oxide layer and an exterior protective layer, such as a layer comprising polyethylene terephthalate.

Multilayer films can comprise any suitable number of tie or adhesive layers of any suitable composition. Various adhesive layers are formulated and positioned to provide a desired level of adhesive between specific layers of the film according to the composition of the layers contacted by the tie layers.

For example adhesive layers in contact with a layer comprising a polyester, such as PET, preferably comprise a suitable blend of polyolefins with other adhesive polymers. One preferred component of an adhesive layer in contact with a PET polyester layer is EMAC SP 1330 (which reportedly has: a density of 0.948 g/cm³; melt index of 2.0 g/10 min.; a melting point of 93° C.; is at softening point of 49° C.; and a methylacrylate (MA) content of 22%).

In embodiments where the layers comprise compatible polymers, the layers can be coextruded or laminated by heat rather than adhered via a tie layer.

The interior, exterior, intermediate or tie layers may be formed of any suitable thermoplastic materials, for example, polyamides, polystyrenes, styrenic copolymers e.g. styrene-butadiene copolymer, polyolefins, and in particular members of the polyethylene family such as LLDPE, VLDPE, HOPE, LDPE, ethylene vinyl ester copolymer or ethylene alkyl acrylate copolymer, polypropylenes, ethylene-propylene copolymers, ionomers, polybutylenes, alpha-olefin polymers, polyesters, polyurethanes, polyacrylamides, anhydride-modified polymers, acrylate-modified polymers, fluoropolymers such as polyCTFE, polyVDF, or CTFE-VDF copolymers, polylactic acid polymers, or various blends of two or more of these materials.

In some embodiments, the exterior, interior and/or one or more intermediate layers can comprise or consist essentially of a nylon blend composition. Preferably, the nylon blend composition comprises at least an amorphous nylon such as nylon 6I/6T copolymer, in combination with at least one semi-crystalline nylon homopolymer or copolymer such as nylon 6/12, 6/69, 6/66, MXD6, 6, 11, or 12.

In some embodiments, one or more of the exterior, interior and/or one or more intermediate layers comprises at least one polyester polymer. Preferred polyester polymers comprise aromatic polyesters and more preferably, are homopolymers or copolymers of poly (ethylene terephthalate) (PET), poly (ethylene naphthalate) and blends thereof. Suitable polyesters may have an intrinsic viscosity of about 0.60 to about 1.2, preferably between 0.60 to 0.80. The polyester may be an aliphatic polyester resin, but is preferably an aromatic polyester resin. For example, polyester materials can be derived from dicarboxylic acid components, including terephthalic acid and isophthalic acid as preferred examples, and also dimers of unsaturated aliphatic acids. Examples of a diol component as another component for synthesizing the polyester may include: polyalkylene glycols, such as ethylene glycol, propylene glycol, tetramethylene glycol, neopentyl glycol, hexamethylene glycol, diethylene glycol, polyethylene glycol and polytetra methylene oxide glycol; 1,4-cyclohexane-dimethanol, and 2-alkyl-1,3-propanediol. More specifically, examples of dicarboxylic acids constituting the polyester resin may include: terephthalic acid, isophthalic acid, phthalic acid, 5-t-butylisophthalic acid, naphthalenedicarboxylic acid, diphenyl ether dicarboxylic acid, cyclohexane-dicarboxylic acid, adipic acid, oxalic acid, malonic acid, succinic acid, azelaic acid, sebacic acid, and dimer acids comprising dimers of unsaturated fatty acids. These acids may be used singly or in combination of two or more species. Examples of diols constituting the polyester resin may include: ethylene glycol, propylene glycol, tetramethylene glycol, neopentyl glycol, hexamethylene glycol, diethylene glycol, polyalkylene glycol, 1,4-cyclohexane-dimethanol, 1,4-butanediol, and 2-alkyl-1,3-propane diol. These diols may be used singly or in combination of two or more species.

Polyester compositions that comprise an aromatic polyester resin comprising an aromatic dicarboxylic acid component can be preferred in some aspects, including, e.g., polyesters between terephthalic acid (as a dicarboxylic acid) and diols having at most 10 carbon atoms, such as polyethylene terephthalate and polybutylene terephthalate. Particularly preferred examples thereof may include: copolyesters obtained by replacing a portion, preferably at most 30 mol %, more preferably at most 15 mol %, of the terephthalic acid with another dicarboxylic acid, such as isophthalic acid; copolyesters obtained by replacing a portion of the diol component such as ethylene glycol with another diol, such as 1,4-cyclohexane-dimethanol (e.g., “Voridian 9921”, made by Voridian division of Eastman Chemical Co.); and polyester-polyether copolymers comprising the polyester as a predominant component (e.g., polyester-ether between a dicarboxylic acid component principally comprising terephthalic acid or/and its ester derivative and a diol component principally comprising tetramethylene glycol and tetramethylene oxide glycol, preferably containing the polytetra methylene oxide glycol residue in a proportion of 10-15 wt. %). It is also possible to use two or more different polyester resins in mixture. Examples of preferred polyesters are available under the trademarks Voridian 9663, Voridian 9921 and EAST AR® Copolyester 6763, all from Eastman Chemical Company, Kingsport, Tenn., U.S.A.

### Optional Additives to Layers

Various additives may be included in the polymers utilized in one or more of the exterior, interior and intermediate or tie layers of packaging comprising the same. For example, a layer may be coated with an anti-block powder. Also, conventional anti-oxidants, antiblock additives, polymeric plasticizers, acid, moisture or gas (such as oxygen) scavengers, slip agents, colorants, dyes, pigments, organoleptic agents may be added to one or more film layers of the film or it may be free from such added ingredients. If the exterior layer is corona treated, preferably no slip agent will be used, but it will contain or be coated with an anti-block powder or agent such as silica or starch. Processing aides are typically used in amounts less than 10%, less than 7% and preferably less than 5% of the layer weight. A preferred processing aid for use in the outer layer of the film includes one or more of fluoroelastomers, stearamides, erucamides, and silicates.

Preferred films may also provide a beneficial combination of one or more or all of the properties including low haze, high gloss, good machinability, good mechanical strength and good barrier properties including high barriers to oxygen and water permeability. Suitable barrier properties may have values of WVTR less than or equal to 0.03 g/100 in²/24 hours at 1 atmosphere and RT; and/or O₂TR values of less than or equal to 10 cm³/100 in²/24 hours at 1 atmosphere and RT. Preferred barrier property values are WVTR=<0.001 g/100 in²/24 hours at 1 atmosphere and RT, and/or O₂TR values of less than or equal to 0.001 cm3/100 in²/24 hours at 1 atmosphere and RT.

### Methods of Manufacture

Monolayer (product-contacting layer) or multilayer films described herein can be made by any suitable process; preferably by conventional processes. Preferably, the process produces a flexible film. Examples of such processes include cast or blown film processes.

In some embodiments, the polymers defined herein are “unmodified” by any intentional grafting or copolymerization with modifying moieties such as dienes, rubber moieties or acrylic acids. However, the polymers may contain chemicals or additives in small amounts (typically under 1% by weight based on the weight of the polymer) which are present as byproducts of the polymer manufacturing process or otherwise added by polymer manufacturers including e.g. catalyst residues, antioxidants, stabilizers, antiblock materials and the like. In some embodiments, the polymers are “modified” or “derivatized” by grafting or copolymerization with modifying moieties. For purposes of the present disclosure, such modified or derivatized polymers are considered a subset of the polymer being modified. For example, a modified or derivatized polyethylene is considered a polyethylene.

Exact and Escorene polymers are the commercial designations of polymers available from Exxon Chemical Company of Houston, Tex., U.S.A. Afinity and Attane polymers are the commercial designations of polymers available from Dow Chemical Company of Midland, Mich., U.S.A. Surlyn and Elvax are the commercial designations of polymers available from Dupont, U.S.A.

Metal foils and metalized films are also contemplated. One or more functional properties may be contributed by one or more layers including desired levels of heat sealability, optical properties e.g. transparency, gloss, haze, abrasion resistance, coefficient of friction, tensile strength, flex crack resistance, puncture resistance, abrasion resistance, printability, colorfastness, flexibility, dimensional stability, barrier properties to gases such as oxygen, or to moisture, light of broad or narrow spectrum including e.g. uv resistance, etc. Preferred materials for use as container walls, pouch films, lidstock, include nylons, polyesters, polystyrenic polymers, and polyolefin e.g. ethylene or propylene homopolymers or copolymers, or mixtures thereof in any number of layers, particularly, but not limited to, one to nine or 14 layers or more. Preferred polyolefins include ethylene homopolymers or copolymers and may include low, medium, high and ultra-low or ultra-high density polymers. Examples are high density polyethylene (HDPE), ethylene alpha-olefin copolymers (EAO) preferably utilizing butene-1, hexene-1, or octene-1 comonomer with a predominate ethylene comonomer portion) and including e.g. linear low density polyethylene (LLDPE), very low density polyethylene (VLDPE), plastomers, elastomers, low density polyethylene (LDPE) copolymers of ethylene and polar groups such as.vinyl acetate or ethyl acrylate e.g. ethylene vinyl acetate (EVA) or ethylene methyl acrylate (EMA) or ethylene acrylic acid copolymer (EAA), functional group modified polyers including e.g. anhydride modified EAOs. Propylene homopolymers and copolymers including polypropylene and propylene ethylene copolymer are useful. Gas diversion or container wall structures may also include a metal or metal oxide layer, which may be a metal foil and may be a metal foil laminate with metal foil and a polymeric layer, such as nylon. It may also be a metal foil laminate with an outer layer of polyethylene terephthalate, a core layer of metal foil and an inner layer of polyethylene. In this arrangement, the polyethylene terephthalate layer serves as a protective layer to the foil, and the polyethylene layer facilitates sealing. A foil or deposited metal or metal oxide layer can be an excellent barrier to materials, organisms, oxygen, moisture and light.

In some embodiments, a packaging film as described herein may utilize a gas barrier layer such as aluminum foil, polyvinylidene chloride copolymers such as saran, or ethylene vinyl alcohol copolymers which provide high barriers to gas permeability.

In some embodiments, a packaging film as described herein may utilize a moisture barrier layer such as aluminum foil, polyvinylidene chloride copolymers such as saran, or polyolefin materials such as LDPE which impede moisture vapor permeation.

Adhesives useful in the present invention include permanent adhesives, modified polymer adhesives and polymer resins commonly available from many commercial sources. It is contemplated that acrylic and anhydride modified polymers may be employed as well as many adhesives which may be selected depending upon other material selections for other functional layers such as the oxygen and/or moisture barrier layer(s) as well as the exterior abuse resistant or protecting layer as well as the CFTE-VDF copolymer containing product contacting layer.

Additives and processing aides; natural and synthetic colorants, pigments and dyes; fillers such as calcium carbonate or carbon black, antimicrobial agents may be incorporated into or coated on one or more layers of the multilayer films of the present invention.

### Film Thickness

Preferably, the packaging film has a total thickness of less than about 10 mils, more preferably the film has a total thickness of from about 1.0 to 10 mils (25-250 microns (μ). Advantageously many embodiments may have a thickness from about 1 to 5 mils, with certain typical embodiments being from about 2 to 3.5 mils. For example, entire multilayer films or any single layer of a multilayer film can have any suitable thicknesses, including 1, 2, 3, 4, 5, 6, 7, 8, 9, or 10 mils, or any increment of 0.1 or 0.01 mil therebetween. Although suitable films for packaging drug patches as thick as 4 mils (101.6 microns) or higher, or as thin as 1 mil (25.4 microns) or less may be made, it is expected that the most common films will be between about 2-4 mil (51-102 microns). Especially preferred for use as films for transdermal patch packaging are films where the multilayer film has a thickness of between about 2 to 3 mils (50.8-76.2 microns). Such films may have good abuse resistance and machinability.

Typical contents for various embodiments of the inventive container may include, for example, transdermal patches, thin strips of dissolvable material for oral administration, as well as articles for collecting or administering a physiologically active substance e.g. a microdiffusion cassette.

Exemplary of commercially available LDPE resin suitable for use in the present invention includes, but are not limited to Equistar 216-000 LDPE resin. Exemplary of commercially available EAA resin for use in the present invention includes, but is not limited to Dupont 3990-L, which is supplied by Dupont de Nemours. Exemplary of commercially available ionomer resin for use in the present invention includes, but is not limited to Dupont 1652-1 Surlyn, which is supplied by Dupont de Nemour. Exemplary of commercially available EAA resin for use in the present invention includes, but is not limited to Dupont 3990-L, which is supplied by Dupont de Nemours.

The mLLDPE layer used in the examples was a blend of 80% LDPE comprising and 20% mLLDPE.

Exemplary of commercially available LDPE resin for use in the present invention includes, but is not limited to Dow 4012 LDPE which is supplied by Dow Chemical Co. of Midland, Mich., USA.

Exemplary of commercially available mLLDPE resin for use in the present invention includes, but is not limited to Exxon Exact 3040 mLLDPE resin, which is supplied by Exxon.

The containers e.g. a pouch can further include a tearing aid or tear initiator such as a notch. Examples of tearing aids or tear initiators such as notches, slits, perforations, surface roughened portions, etc., are described in U.S. Pat. Nos. 4,778,058; 3,608,815; 4,834,245; 4,903,841; 5,613,779; 5,988,489; 6,102,571; 6,106,448; 6,541,086; 7,470,062; and 7,481,581. Such tear initiators may be used on one or more edges of the inventive pouch and package.

Advantageously the tear initiator may be used with scoring e.g. mechanical or laser scoring of one or more layers, preferably the other abuse resistance layer, to create a tear directing line which facilitates opening. Prior art films used for packaging transdermal patches which utilize polyacrylonitrile as the patch contact surface layer (sealant layer) have undesirably poor tear properties, being very susceptible to delamination upon attempts to tear open even with scoring. These packages typically must use scissors or a knife for opening. Beneficially, the present invention has excellent tear properties and when used with a score line may be manually opened in a clean, non-delaminating fashion without use of scissors or other cutting implements. This easy to open feature of the present invention may be coupled with child resistant packaging technology such as that described in pending patent application number PCTIUS2013/022101, which is hereby incorporated by reference in its entirety, to provide a child resistant package which is simultaneously easy to open by an adult.

### Packaged Product

Any product for which scalping may be a concern can be packaged with a film as described herein. In various embodiments, the product includes a pharmaceutical product. For purposes of the present disclosure, a pharmaceutical composition is considered to be a pharmaceutical product.

Pharmaceutical products may contain one or more pharmaceutical excipients. Preferably, the product-contacting layer of a film used to package a pharmaceutical product is compatible with and anti-scalping with regard to the excipients present in the package. Excipients that may be included in various types of pharmaceutical products are generally known to those of ordinary skill in the pharmaceutical arts, some of which are described in Remington: The Science and Practice of Pharmacy, 22^{nd} edition, Loyd V. Allen, Jr. (editor), Pharmaceutical Press, September 2012.

A pharmaceutical product for packaging in a film described herein can include any suitable pharmaceutical active agent. In some embodiments, the pharmaceutical active agent is selected from the group consisting of acetylfentanly, fentanyl, nicotine, lidocaine, estradiol, clonidine, ethinyl estradiol, oxybutynin, buprenorphine, granisitron, methylphenidate, and scopolamine. In some embodiments, one or more of the listed pharmaceutical active agents are included in a transdermal patch.

Examples of some excipients that may be present in a transdermal patch include solvents, preservatives, and permeation enhancers. Examples of some particular excipients include isopropyl myristate, ethyl lactate, lauryl lactate, dimethylsulfoxide (DMSO), capric acid, dipropylene glycol, ethanol, oleic acid, triacetin, isopropyl palmitate, water, tetradecane and the like.

A pharmaceutical product can be packaged in a film described herein in any suitable manner. In some embodiments, a pharmaceutical product is packaged such that the pharmaceutical active agent is not in contact with a sealing layer of the film. In some embodiments, the pharmaceutical product is packaged such that the pharmaceutical active agent is in contact with the sealing layer of the film. The active agent can be in direct contact with the sealing layer or in indirect contact with the sealing layer.

In some embodiments, the pharmaceutical product comprises a gel, paste, solution or the like, where gel, paste, solution, etc. contains the active ingredient and is in direct contact with the sealing layer.

In some embodiments, the pharmaceutical product includes an active agent or excipient that acts as a carrier for the active agent where the active agent or the carrier have a vapor pressure sufficiently high to cause volatilization of the active agent or carrier to cause the active agent to contact the sealing layer upon storage, even though the product is initially packaged such that active agent is not in direct contact with the sealing layer.

In some embodiments, the pharmaceutical product includes a transdermal patch. Transdermal patches typically have a release liner covering a matrix comprising a pharmaceutical active agent. Accordingly, the pharmaceutical active agent and excipients of a transdermal patch having a release liner may not be in direct contact with the sealing layer of film in which it is packaged. However, at an edge of the release liner, some of the matrix may come into direct contact with the sealing layer and may allow the active agent to be wicked towards the sealing layer. Alternatively or in addition, the vapor pressure of the active agent or a carrier excipient may be sufficiently high to cause the active agent to contact the sealing layer upon storage. By way of example, nicotine, which is often included in transdermal patches, is fairly volatile and has a vapor pressure of 5.65 Pa at 25° C.

In some embodiments, the pharmaceutical product is packaged in a film described herein such that the pharmaceutical active agent is not in contact with the sealant layer. For example, the active agent may be surrounded by a backing and a release liner or may be otherwise contained such that active agent is not in contact with the sealing layer. In such cases, it can still be desirable to have a sealing layer that would be anti-scalping if the active agent were to come into contact with the sealing layer. For example, if the pharmaceutical product includes a release liner configured to prevent contact of the active agent with the sealing layer, the release liner may slip or otherwise partially release during packaging, shipping, storage or the like to expose the active agent to the sealing layer. Even in there is little or no risk that the active agent may be exposed to the sealing layer, it may be desirable for the sealing layer to be anti-scalping for purposes of caution, reassurance, or the like.

When a pharmaceutical product is packaged in a film such that the product contacting sealing layer of the film is in indirect contact with a pharmaceutical active agent of the product, detectable amounts of the pharmaceutical agent are present at a surface of the product contacting layer or migrate into the product contacting layer upon storage of the product in the packaging film. Any suitable technique can be employed to determine whether a pharmaceutical agent of a pharmaceutical product indirectly contacts a layer of a package in which the produce is sealed. That is, if a detectable amount of the agent is present at a surface of a layer or in a layer of the film, then the pharmaceutical agent is “in contact” with the layer of the film for purposes of the present disclosure. Examples of suitable techniques that can be employed to determine whether a pharmaceutical agent of a pharmaceutical product indirectly contacts a layer of a package in which the produce is sealed include Raman spectroscopy, gas chromatography, gas chromatography-mass spectrometry (GCMS), liquid chromatography-mass spectrometry (LCMS), high performance liquid chromatography (HPLC) and the like.

To determine whether a pharmaceutical active agent of a pharmaceutical product is in indirect contact with a sealing layer of a film, the presence of the active agent at or in a sealing layer of the film can be evaluated after the pharmaceutical product has been packaged in the film under storage conditions for an amount of time. The storage conditions and time can be standard storage conditions. The standard storage conditions can be accelerated storage conditions; e.g. at temperatures above room temperature. For examples, the storage conditions can be 20% relative humidity and a temperature of 100° F. for 1, 7, 15 or 31 days.

Alternatively or in addition, to determine whether a pharmaceutical active agent of a pharmaceutical product would be in indirect contact with a sealing layer of a film described herein, the presence of the active agent at or in a surrogate sealing layer of the film can be evaluated after the pharmaceutical product has been packaged in the surrogate film under standard storage conditions for a standard amount of time. Preferably, the surrogate film is not anti-scalping or is not as anti-scalping as a film as described herein. The product can be packaged and stored in the film containing the surrogate sealing layer in a manner similar to how the pharmaceutical product packaged in a film as described herein would be packaged and stored. If the active agent migrates into the surrogate sealing layer, then the active agent can be considered to be “in contact” with the surrogate layer and would be considered to be “in contact” with a sealing layer of any film in which it was stored, such as a film as described herein.

### Anti-Scalping

Whether a product contacting layer of a film performs effectively as an anti-scalping layer can be a subjective determination, with differing amounts of migration of a pharmaceutical active agent into a layer of a film being considered acceptable depending on, among other things, the active agent, the amount that the active agent migrates into layers of other films, and the like.

For purposes of the present application, a product contacting layer of a film is considered to serve as an effective anti-scalping layer if (i) a lower amount of the active agent migrates into the product contacting layer of the film (the test film) than migrates into a substantially similar film having a PE, such as a linear low density polyethylene homopolymer, product contacting layer (the reference film) when a product containing the pharmaceutical active agent is positioned relative to the test and reference films such that the pharmaceutical active agent is in direct contact with the product contacting layers of the test and reference films; or (ii) an amount of the active agent migrates into the product contacting layer of the film (the test film) is not more than 15% greater than migrates into a substantially similar film having a Barex® product contacting layer (the reference film) when a product containing the pharmaceutical active agent is positioned relative to the test and reference films such that the pharmaceutical active agent is in direct contact with the product contacting layers of the test and reference films. Preferably, the product is sealed in a cavity formed, at least in part, by the test film and the product is sealed in a cavity formed, at least in part, by the reference film. The sealed product can be stored under identical conditions prior to testing to determine whether less active agent has migrated into the product contacting layer of the test film than the reference film. The storage conditions may be accelerated storage conditions as described above.

Any suitable technique may be employed to determine whether to determine whether less active agent has migrated into the product contacting layer of the test film than the reference film. For example, Raman spectroscopy or gas chromatography, can be used.

In some embodiments, the amount of an active pharmaceutical agent that migrates into a film having a linear low density polyethylene homopolymer as a product contacting layer (as described above) will be 1.5 times or more than the amount of the pharmaceutical active agent that migrates into an anti-scalping product contact layer of a film as described herein. In some embodiments, the amount of an active pharmaceutical agent that migrates into a film having a linear low density polyethylene homopolymer as a product contacting layer (as described above) will be 2 times or more, 3 times or more, or 4 times or more, or 5 times or more than the amount of the pharmaceutical active agent that migrates into an anti-scalping product contact layer of a film as described herein.

In preferred embodiments, an amount of an active pharmaceutical agent that migrates into a film having a CFTE-VDF copolymer as described herein as a sealing layer will be no more than 10% more than the amount of the pharmaceutical active agent that migrates into film having Barex® as a sealing layer. More preferably, the amount of an active pharmaceutical agent that migrates into a film having a CFTE-VDF copolymer as described herein as a sealing layer will be no more than 9% (no more than 8%, no more than 7%, no more than 6%, no more than 5%, no more than 4%, no more than 3%, no more than 2%, or no more than 1%) more than the amount of the pharmaceutical active agent that migrates into film having Barex® as a sealing layer.

A preferred method for determining whether a film is anti-scalping is to compare active agent uptake relative to a linear low density polyethylene homopolymer or Barex® as described above. In preferred embodiments a drug take test is performed generally as follows:

Ten pouches are made with each test film by heat sealing together two pieces of the sample film each measuring 3×3.5 inches on three sides with the same article contact surface facing each other. Next, a standard amount of the drug being tested is placed on a 1×1.25 inch piece of blotter paper and the blotter paper is placed inside the pouch which is then heat sealed.

The pouches are stored at 100° F. and 20% RH and three pouches of each film structure are tested at reported intervals e.g. days 1, 7, 15 and 31. After the allotted time, three pouches are opened by cutting an end seal, and the blotters removed. The blotterless pouches are rinsed with distilled water to remove any drug residue that might be present on the surface of the sealant and excess water is removed from the pouches by shaking. Next, 5 ml of isopropanol spiked with an internal standard (propylene glycol n-propyl ether) is placed in each pouch which is then resealed with heat seals. The resealed pouches are placed on a shaker table for 90 minutes to facilitate drug extraction from the sealant. Finally, the pouch extracts are analyzed by gas chromatography and the amount of eluted drug is calculated for each pouch.

### FIGURES

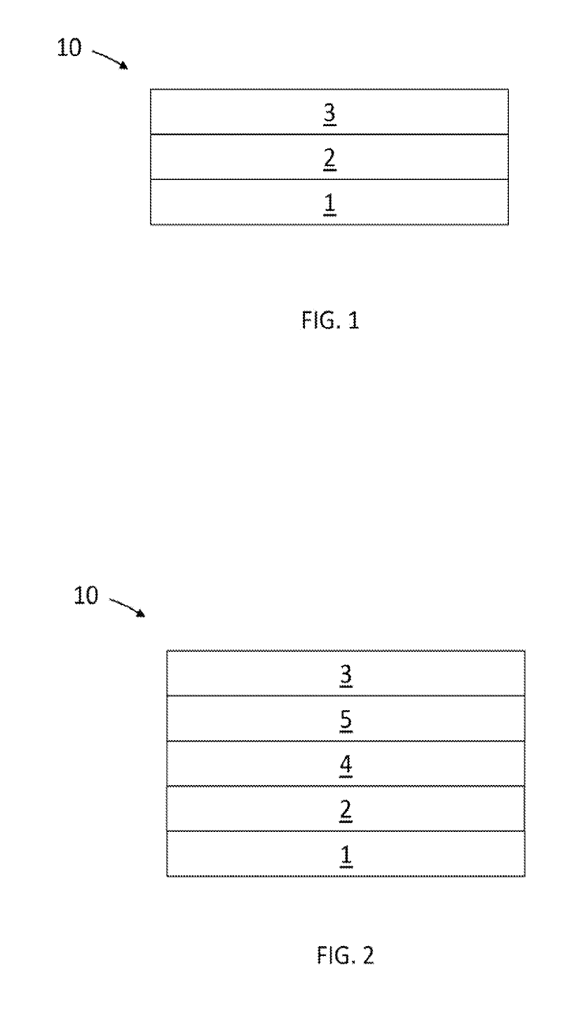

Referring now to the Drawings, FIG. 1 is a schematic drawing of a cross-section of an embodiment of a multilayer film 10. In the depicted embodiment, the film 10 includes three layers. On one surface is the product-contacting layer 1, which comprises a CFTE-VDF copolymer. Adjacent and in contact with the product-contacting layer 1 is an adhesive layer 2. Adjacent and in contact with the adhesive layer 2 is an exterior protective layer 3.

Referring now to FIG. 2, a schematic drawing of a cross-section of an embodiment of a multilayer film 10 is shown. In the depicted embodiment, the film 10 includes five layers. On one surface is the product-contacting layer 1, which comprises a CFTE-VDF copolymer. Adjacent and in contact with the product-contacting layer 1 is an adhesive layer 2. Adjacent and in contact with the adhesive layer 2 is an oxygen barrier layer 4. The oxygen barrier layer can be a metal foil or deposited metal or metal oxide such as aluminum oxide, silicon oxide, metalized PET, or the like. Adjacent and in contact with the oxygen barrier layer 4 is a bulk layer 5, such as a layer that comprises a polyolefin such as polyethylene. The bulk layer 5, in some embodiments, is a tie or adhesive layer. Adjacent and in contact with the bulk layer 5 is an exterior protective layer 3. The bulk layer 5, in some embodiments, can be coextruded with the exterior protective layer 3.

In some embodiments, a single roll web of pouch film can be placed on a packaging machine and folded together and heat sealed and severed to form heat sealed pouches. Two side sealed pouches with a folded third side can be used to package an article by a manufacturer or packager who places a product in the pouch, and completes the final seal to produce a hermetically sealed package containing for example: a transdermal drug delivery patch; an oral dissolvable thin strip containing a drug, flavorant, antimicrobial agent, odorant, and/or microbiologically active ingredient or combination thereof; or an article for collecting or administering a physiologically active substance.

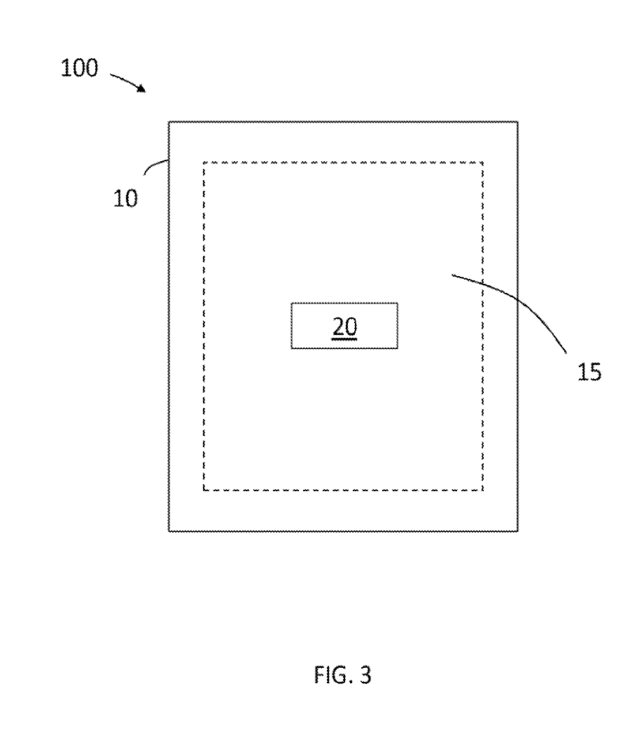

Referring now to FIG. 3, a schematic drawing of a packaged product 100 is shown. The packaged product includes a product 20, such as a pharmaceutical product, sealed within an interior 15 of a package that includes film 10. The product 20 is in contact with a product-contacting layer of film 10. In some embodiments, the package consists essentially of the film 10. In some embodiments, two or more films may be sealed together to form sealed interior 15 or film 10 can be sealed to a container such that the film and container form the interior. In any case, the film 10 forms at least a portion of the interior 15 of the package. In the depicted embodiment, the dashed lines indicated the sealed portion of the package that defines sealed interior 15.

### Definitions and Nomenclature

In discussing polymer blends, plastic films and packaging, various acronyms are used herein and they are listed below. Also, in referring to blends of polymers a colon (:) will be used to indicate that the components to the left and right of the colon are blended. In referring to film structure, a slash “/” will be used to indicate that components to the left and right of the slash are in different layers and the relative position of components in layers may be so indicated by use of the slash to indicate film layer boundaries. Acronyms and terms commonly employed herein include:
APET—amorphous polyester terephthalate
OPET—biaxially oriented polyester terephthalate
CTFE—chlorotrifluoroethylene
VDF—vinylidene fluoride
CTFE-VDF copolymer—a copolymer formed from CTFE monomers and VDF monomers
PE—Polyethylene (ethylene homopolymer and/or copolymer of a major portion of ethylene with one or more α-olefins)
LDPE—low density polyethylene
LLDPE—linear low density polyethylene
mLLDPE—metallocene catalyzed linear low density polyethylene
C₂-ethylene monomer
C₄-butene-1 monomer
C₆-hexene-1 monomer
C₈-octene-1 monomer
C₁₀-decene-1 monomer
C₂Cₓ—a substantially linear copolymer of ethylene and an α-olefin where “x” indicates the number of carbon atoms in the comonomer.
VA—Vinyl Acetate
EVA—Copolymer of ethylene with vinyl acetate
EVOH—A saponified or hydrolyzed copolymer of ethylene and vinyl acetate
EAA—Copolymer of ethylene with acrylic acid
EMA—ethylene methacrylic acid copolymer ionomer—an ethylene-methacrylate acid copolymer whose acid groups have been neutralized partly or completely to form a salt, preferably a zinc or sodium salt
PVDC—Polyvinylidene chloride (also includes copolymers of vinylidene chloride, especially with vinyl chloride)
EVAL—EVOH films from 12-25 microns thick available from Kuraray America, Inc., Houston, Tex.

The term “nanocomposite” shall mean a mixture that includes a polymer, or copolymer having dispersed therein a plurality of individual platelets obtained from an exfoliated modified clay and having oxygen barrier properties.

The term “adhesive layer,” or “tie layer,” refers to a layer or material placed on one or more layers to promote the adhesion of that layer to another surface. Preferably, adhesive layers are positioned between two layers of a multilayer film to maintain the two layers in position relative to each other and prevent undesirable delamination. In some embodiments a peelable tie layer may be used which is designed to have either cohesive failure or delamination from one or both adjacent layers upon application of a suitable manual force to provide an opening feature for a package made from the film. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may comprise components of both the first layer and the second layer to promote simultaneous adhesion of the adhesive layer to both the first layer and the second layer to opposite sides of the adhesive layer.

As used herein, unless otherwise indicated, the phrases “seal layer,” “sealing layer,” “heat seal layer,” and “sealant layer,” refer to a film layer, or layers, involved in the sealing of the film: to itself; to another film layer of the same film or another film; and/or to another article which is not a film e.g. a tray. In general, the sealant layer is a surface layer i.e. an exterior or an interior layer of any suitable thickness, that provides for the sealing of the film to itself or another layer. With respect to packages having only fin-type seals, as opposed to lap-type seals, the phrase “sealant layer” generally refers to the interior surface film layer of a package. The inside layer frequently can also serve as an article contact layer in the packaging of articles.

The terms “heat sealing layer,” “sealing layer,” “seal layer,” or “sealant layer” are used interchangeably to refer to a layer which is heat sealable i.e., capable of fusion bonding by conventional indirect heating means which generate sufficient heat on at least one film contact surface for conduction to the contiguous film contact surface and formation of a bond interface therebetween without loss of the film integrity. The bond interface between contiguous inner layers preferably has sufficient physical strength to withstand the packaging process and subsequent handling. Advantageously, the bond interface is preferably sufficiently thermally stable to prevent gas or liquid leakage therethrough when exposed to above or below ambient temperatures e.g. during one or more of the following: packaging operations, storage, handling, and transport. Heat seals may be designed to meet different conditions of expected use and various heat seal formulations are known in the art and may be employed with the present invention. Preferably the article contact or heat seal layer is heat sealable to itself, but may be sealable to other objects, films or layers e.g. to a tray when used as a lidding film, or to an outer layer in a lap seal or in certain tray overwrap embodiments.

“Polyolefin” is used herein broadly to include polymers such as polyethylene, ethylene-alpha olefin copolymers (EAO), polypropylene, polybutene, ethylene copolymers having a majority amount by weight of ethylene polymerized with a lesser amount of a comonomer such as vinyl acetate, and other polymeric resins falling in the “olefin” family classification. Polyolefins may be made by a variety of processes well known in the art including batch and continuous processes using single, staged or sequential reactors, slurry, solution and fluidized bed processes and one or more catalysts including for example, heterogeneous and homogeneous systems and Ziegler, Phillips, metallocene, single site and constrained geometry catalysts to produce polymers having different combinations of properties. Such polymers may be highly branched or substantially linear and the branching, dispersity and average molecular weight and may vary depending upon the parameters and processes chosen for their manufacture in accordance with the teachings of the polymer arts.

“Polyethylene” is the name for a polymer whose basic structure is characterized by the chain —(CH₂—CH₂—)ₙ. Polyethylene homopolymer is generally described as being a solid which has a partially amorphous phase and partially crystalline phase with a density of between 0.915 to 0.970 g/cm³. The relative crystallinity of polyethylene is known to affect its physical properties. The amorphous phase imparts flexibility and high impact strength while the crystalline phase imparts a high softening temperature and rigidity.

Unsubstituted polyethylene is generally referred to as high density homopolymer and has a crystallinity of 70 to 90 percent with a density between about 0.96 to 0.97 g/cm³. Most commercially utilized polyethylenes are not unsubstituted homopolymer but instead have C₂-C₈ alkyl groups attached to the basic chain. These substituted polyethylenes are also known as branched chain polyethylenes. Also, commercially available polyethylenes frequently include other substituent groups produced by copolymerization. Branching with alkyl groups generally reduces crystallinity, density and melting point. The density of polyethylene is recognized as being closely connected to the crystallinity. The physical properties of commercially available polyethylenes are also affected by average molecular weight and molecular weight distribution, branching length and type of substituents.

People skilled in the art generally refer to several broad categories of polymers and copolymers as “polyethylene.” Placement of a particular polymer into one of these categories of “polyethylene” is frequently based upon the density of the “polyethylene” and often by additional reference to the process by which it was made since the process often determines the degree of branching, crystallinity and density. In general, the nomenclature used is nonspecific to a compound but refers instead to a range of compositions. This range often includes both homopolymers and copolymers.

For example, “high density” polyethylene (HDPE) is ordinarily used in the art to refer to both (a) homopolymers of densities between about 0.960 to 0. 970 g/cm³ and (b) copolymers of ethylene and an α-olefin (usually 1-butene or 1-hexene) which have densities between 0.940 and 0.958 g/cm³. HDPE includes polymers made with Ziegler or Phillips type catalysts and is also said to include high molecular weight “polyethylenes.” In contrast to IIDPE, whose polymer chain has some branching, are “ultra high molecular weight polyethylenes” which are essentially unbranched specialty polymers having a much higher molecular weight than the high molecular weight HOPE.

Hereinafter, the term “polyethylene” will be used (unless indicated otherwise) to refer to ethylene homopolymers as well as copolymers of ethylene with α-olefins and the term will be used without regard to the presence or absence of substituent branch groups. Another broad grouping of polyethylene is “high pressure, low density polyethylene” (LDPE). LDPE is used to denominate branched homopolymers having densities between 0.915 and 0.930 g/cm³. LDPEs typically contain long branches off the main chain (often termed “backbone”) with alkyl substituents of 2 to 8 carbon atoms.

Linear Low Density Polyethylene (LLDPE) are copolymers of ethylene with alpha-olefins having densities from 0.915 to 0.940 g/cm³. The α-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). An LLDPE produced with a metallocene or constrained geometry catalyst is often referred to as “mLLDPE”.

Ethylene α-olefin copolymers are copolymers having an ethylene as a major component copolymerized with one or more alpha olefins such as octene-1, hexene-, or butene-1 as a minor component. EAOs include polymers known as LLDPE, VLDPE, ULDPE, and plastomers and may be made using a variety of processes and catalysts including metallocene, single-site and constrained geometry catalysts as well as Ziegler-Natta and Phillips catalysts.

Very Low Density Polyethylene (VLDPE) which is also called “Ultra Low Density Polyethylene” (ULDPE) comprise copolymers of ethylene with α-olefins, usually 1-butene, 1-hexene or 1-octene and are recognized by those skilled in the art as having a high degree of linearity of structure with short branching rather than the long side branches characteristic of LDPE. However, VLDPEs have lower densities than LLDPEs. The densities of VLDPEs are recognized by those skilled in the art to range between 0.860 and 0.915 g/cm³. Sometimes VLDPEs having a density less than 0.900 g/cm³ are referred to as “plastomers”.

Polyethylenes may be used alone, in blends and/or with copolymers in both monolayer and multilayer films for packaging applications.

As used herein, the term “modified” refers to a chemical derivative e.g. one having any form of anhydride functionality, such as anhydride of maleic acid, crotonic acid, citraconic acid, itaconic acid, fumaric acid, etc., whether grafted onto a polymer, copolymerized with a polymer, or otherwise functionally associated with one or more polymers, and is also inclusive of derivatives of such functionalities, such as acids, esters, and metal salts derived therefrom. Another example of a common modification is acrylate modified polyolefins.

As used herein, terms identifying polymers, such as e.g. “polyamide” or “polypropylene,” are inclusive of not only polymers comprising repeating units derived from monomers known to polymerize to form a polymer of the named type, but are also inclusive of comonomers, as well as both unmodified and modified polymers made by e.g. derivitization of a polymer after its polymerization to add functional groups or moieties along the polymeric chain. Furthermore, terms identifying polymers are also inclusive of “blends” of such polymers. Thus, the terms “polyamide polymer” and “nylon polymer” may refer to a polyamide-containing homopolymer, a polyamide-containing copolymer or mixtures thereof.

The term “polyamide” means a high molecular weight polymer having amide linkages (—CONH—)ₙ. which occur along the molecular chain, and includes “nylon” resins which are well known polymers having a multitude of uses including utility as packaging films, bags, and pouches. See, e.g. Modern Plastics Encyclopedia, 88 Vol. 64, No. 10A, pp 34-37 and 554-555 (McGraw-Hill, Inc., 1987) which is hereby incorporated by reference. Polyamides are preferably selected from nylon compounds approved for use in producing articles intended for use in processing, handling, and packaging food or drugs.

The term “nylon” as used herein it refers more specifically to synthetic polyamides, either aliphatic or aromatic, either in crystalline, semi-crystalline, or amorphous form characterized by the presence of the amide group —CONH. It is intended to refer to both polyamides and co-polyamides.

Thus the terms “polyamide” or “nylon” encompass both polymers comprising repeating units derived from monomers, such as caprolactam, which polymerize to form a polyamide, as well as copolymers derived from the copolymerization of caprolactam with a comonomer which when polymerized alone does not result in the formation of a polyamide. Preferably, polymers are selected from compositions approved as safe for producing articles intended for use in processing, handling and packaging of food or drugs, such as nylon resins approved by the U.S. Food and Drug Administration provided at 21 CFR § 177.1500 (“Nylon resins”), which is incorporated herein by reference. Examples of these nylon polymeric resins for use in food or drug packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 61/6T disclosed at 21 CFR §177.1500. Examples of such polyamides include nylon homopolymers and copolymers such as those selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-cododecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof.

In use of the term “amorphous nylon copolymer,” the term “amorphous” as used herein denotes an absence of a regular three-dimensional arrangement of molecules or subunits of molecules extending over distances which are large relative to atomic dimensions. However, regularity of structure may exist on a local scale. See, “Amorphous Polymers,” Encyclopedia of Polymer Science and Engineering, 2nd Ed., pp. 789-842 (J. Wiley & Sons, Inc. 1985). In particular, the term “amorphous nylon copolymer” refers to a material recognized by one skilled in the art of differential scanning calorimetry (DSC) as having no measurable melting point (less than 0.5 cal/g) or no heat of fusion as measured by DSC using ASTM 3417-83. The amorphous nylon copolymer may be manufactured by the condensation of hexamethylenediamine, terephthalic acid, and isophthalic acid according to known processes. Amorphous nylons also include those amorpihous nylons prepared from condensation polymerization reactions of diamines with dicarboxylic acids. For example, an aliphatic diamine is combined with an aromatic dicarboxylic acid, or an aromatic diamine is combined with an aliphatic dicarboxylic acid to give suitable amorphous nylons.

As used herein, “EVOH” refers to ethylene vinyl alcohol copolymer. EVOH is otherwise known as saponified or hydrolyzed ethylene vinyl acetate copolymer, and refers to a vinyl alcohol copolymer having an ethylene comonomer. EVOH is prepared by the hydrolysis (or saponification) of an ethylene-vinyl acetate copolymer. The degree of hydrolysis is preferably from about 50 to 100 mole percent, more preferably, from about 85 to 100 mole percent, and most preferably at least 97%. It is well known that to be a highly effective oxygen barrier, the hydrolysis-saponification must be nearly complete, i.e. to the extent of at least 97%. EVOH is commercially available in resin form with various percentages of ethylene and there is a direct relationship between ethylene content and melting point. For example, EVOH having a melting point of about 175° C. or lower is characteristic of EVOH materials having an ethylene content of about 38 mole % or higher. EVOH having an ethylene content of 38 mole % has a melting point of about 175° C. With increasing ethylene content the melting point is lowered. Also, EVOH polymers having increasing mole percentages of ethylene have greater gas permeabilities. A melting point of about 158° C. corresponds to an ethylene content of 48 mole %. EVOH copolymers having lower or higher ethylene contents may also be employed. It is expected that processability and orientation would be facilitated at higher contents; however, gas permeabilities, particularly with respect to oxygen, may become undesirably high for certain packaging applications which are sensitive to microbial growth in the presence of oxygen. Conversely lower contents may have lower gas permeabilities, but processability and orientation may be more difficult.

As used herein, the term “polyester” refers to synthetic homopolymers and copolymers having ester linkages between monomer units which may be formed by condensation polymerization methods. Polymers of this type are preferable aromatic polyesters and more preferable, homopolymers and copolymers of poly(ethylene terephthalate), poly(ethylene isophthalate), poly(butylene terephthalate), poly(ethylene naphthalate) and blends thereof. Suitable aromatic polyesters may have an intrinsic viscosity between 0.60 to 1.0, preferably between 0.60 to 0.80.

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all of the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the inventive technology.

For purposes of the present disclosure, recitations of numerical ranges by endpoints include all numbers subsumed within that range (e.g., 1 to 5 includes 1, 1.5, 2, 2.75, 3, 3.80, 4, 5, etc.). Where a range of values is “greater than”, “less than”, etc. a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a product-contacting layer comprising a CTFE-VDF copolymer include embodiments where a product-contacting layer consists of a CTFE-VDF copolymer and embodiments where a product-contacting layer consists essentially of a CTFE-VDF copolymer.

Following are examples given to illustrate the invention, but these examples should not be taken as limiting the scope. All percentages are by weight unless indicated otherwise.

### EXAMPLES

### Example 1—Characterization of PFX-14-12 Film

Two CFTE-VDF copolymer films were obtained from Honeywell International, Inc. One film, PFX-14-12, was a 1.5 mil monolayer film. The other film, PFX-14-13, was a 3.0 mil monolayer film. The PFX-14-12 film was tested by Fourier transform infrared spectroscopy-attenuated total reflectance (FTIR-ATR) and differential scanning calorimetry (DSC). Results indicated that a PCTFE component is present in the PFX-14-12 copolymer. The peaks at 1182.6 cm⁻¹ 1191.1 cm⁻¹ and 1119.6 cm⁻¹ and 962.1 cm⁻¹ on the PFX-14-12 copolymer, are all reflected on the PCTFE homopolymer spectrum. Peaks at 2850 cm⁻¹ and 2950 cm⁻¹ correspond to C—H stretching bonds that indicates the presence of a PVDF component.

The DSC analysis indicates glass transition temperature of the PFX-14-12 copolymer of around 50° C. and a melting temperature of 185.78° C. The melting temperature PCTFE homopolymer is about 210° C. The incorporation of the PVDF into the highly crystallized PCTFE chain would be expected to interrupt the regularity of the chain structure and thus lowers its melting point.

### Example 2—Antiscalping Properties of CFTE-VDF Copolymer

Nicotine vapor test: A number of different polymerswere tested for their ability to resist uptake of nicotine. Monolayer polymer sheets were cut into 1 inch by ⅜ inch strips. The strips were then clipped individually on a wire, and hung in a jar filled with 50 ml nicotine at the bottom. The strip samples were exposed to nicotine vapor for 2 weeks.

After the allotted time, the strip samples are rinsed with distilled water to remove any liquid nicotine that might be present on the surface of the sealant and excess water is removed from the pouches. Next, the strip samples are placed in 5 ml of isopropanol spiked with an internal standard (propylene glycol n-propyl ether) and placed on a shaker table for 90 minutes to facilitate nicotine extraction from the sealant. Finally, the pouch extracts are analyzed by gas chromatography and the amount of eluted nicotine is calculated for each strip.

Nicotine uptake values are listed in Table 1. (All values are shown as nicotine peak area from the GC, not real uptake weight).

TABLE 1
Nicotine Vapor Test Results: Week 2 Data

Polymer

| Sample | 1 | 2 | 3 | 4 |
|---|---|---|---|---|
| 1 | 0 | 1303 | 16 | 58 |
| 2 | 0 | 1130 | 14 | 50 |
| 3 | 0 | 1203 | 27 | 91 |
| 4 | 0 | 1208 | 18 | 51 |
| Average | 0 | 1211 | 18 | 63 |

In Table 1 above, Polymer 1 is Barex®, Polymer 2 is a representative high barrier copolyester in the TRITAN (Eastman) family, Polymer 3 is PFX-14-12 copolymer, and Polymer 4 is blend of PE and EVA (5% VA content). Polymer 2 was tested as a 4 mil thick sheet. For all other polymers the sheets were between 1 and 2 mil thick.

As shown from Table 1, PFX-14-12 (polymer 3) serves as an effective barrier for resisting nicotine migration. PFX-14-12 is nearly as effective as Barex® (polymer 1). PFX-14-12 (polymer 3) was more effective at resisting nicotine migration than a number of the other tested polymers.

Nicotine direct contact test: 1 inch by ⅜ inch sample strips were sandwiched between two layers of blotter paper. 1.6 ml of nicotine were evenly deposited on each layer. The blotter papers were stapled together and placed in a clean glass jar. The strip samples were in close contact with nicotine for 4 different time points: 1, 2, 4, 6 weeks.

After the allotted time, the strip samples are rinsed with distilled water to remove any liquid nicotine that might be present on the surface of the sealant and excess water is removed from the pouches by shaking. Next, the strip samples are placed in 5 ml of isopropanol spiked with an internal standard (propylene glycol n-propyl ether) and placed on a shaker table for 90 minutes to facilitate nicotine extraction from the sealant. Finally, the pouch extracts are analyzed by gas chromatography and the amount of eluted nicotine is calculated for each strip.

The nicotine uptake values are listed in Tables 2, 3 and 4. (All values are shown as nicotine peak area from the GC, not real uptake weight).

TABLE 2
Nicotine Direct Contact: Week 1 Data

| Sample | Barex ® | PFX-14-12 | CXB |
|---|---|---|---|
| 1 | 0 | 23.1 | 451.5 |
| 2 | 0 | 22.8 | 474.4 |
| 3 | 0 | 21.4 | 433.5 |
| Average | 0 | 22.4 | 453.1 |

TABLE 3
Nicotine Direct Contact: Week 2 Data

| Sample | Barex ® | PFX-14-12 | CXB |
|---|---|---|---|
| 1 | 1.7 | 37.7 | 629.9 |
| 2 | 0 | 38.5 | 704.6 |
| 3 | 0 | 35.9 | 671.9 |
| Average | 0.6 | 37.4 | 668.8 |

TABLE 4
Nicotine Direct Contact: Week 2 Data

| Sample | Barex ® | PFX-14-12 | CXB |
|---|---|---|---|
| 1 | 0 | 56.9 | 400 |
| 2 | 0 | 53 | 357.2 |
| 3 | 0 | 62.3 | 417.5 |
| Average | 0 | 57.4 | 391.6 |

As shown in Tables 2-4, PFX-14-12 is a better barrier for resisting nicotine migration than CXB and is very close to as effective as Barex®. CXB is an ethylene norbornene copolymer from 35 wt. % ethylene monomers and 65 wt. % norbornene monomers, which is described in more detail in PCT patent application PCT/US15/15246, entitled ANTI-SCALPING PHARMACEUTICAL PACKAGING FILM, filed on 10 Feb. 2015, which application is hereby incorporated herein by reference to the extent that it does not conflict with the disclosure presented herein

### Example 2: Uptake of Lidocaine and Acetylfentanyl

### Materials and Methods

1″×0.25″ strips of candidate polymer film were cut out and sandwiched between blotting paper completely soaked with (i) lidocaine (10 mg/mL) or (ii) acetylfentanyl (1 mg/mL). The blotting paper containing the samples was stapled together to ensure conformal contact with samples, enveloped in foil to prevent drying, and kept in an aging chamber (100 F, 20% RH). Samples were taken out at different time-points and washed by incubation in 1.5 ml distilled water followed by shaking for 3 mins to wash off excess drug on the surface. Samples were then incubated with 1.5 mL of (i) isopropanol (for lidocaine) or (ii) methanol (for acetylfentanyl) on a shaker overnight to extract the drugs absorbed by the strips. The extraction solvent was analyzed using GC-FID. Area under peaks facilitate comparison of relative mass uptake of the drugs by different materials.

### Results

The results for lidocaine uptake are shown in Table 5 below. As indicated, lidocaine uptake in Barex® or polyethylene (PE) was about 100 times to about 200 times greater than uptake by PFX-14-12, for which uptake was almost negligible. CXB also exhibited excellent anti-scakping properties with regard to lidocaine.

TABLE 5
Lidocaine uptake

Lidocaine uptake (Area under peak - GC-FID)

| Material | Day 7 | Day 14 | Day 30 |
|---|---|---|---|
| Barex ® | 245.43 | 294.63 | 1218.67 |
| CXB | 1.53 | 2.33 | 10.13 |
| PE | 254.47 | 245.33 | 401.07 |
| PFX-14-12 | 1.17 | 0.00 | 7.25 |

The results for acetylfentanyl uptake are shown in Table 6 below. As indicated, uptake was in Barex® and polyethylene (PE), but not in PFX-14-12 even after 90 days in the aging chamber. Again, CXB also exhibited excellent anti-scakping properties.

TABLE 6
Acetylfentanyl uptake

| | Acetrylfentanyl uptake (Area under peak - GC-FID) | | |
|---|---|---|---|
| Material | Day 14 | Day 28 | Day 90 |
| Barex ® | 22.00 | 2.77 | 15.80 |
| CXB | 0.00 | 0.00 | 0.00 |
| PE | 10.93 | 33.27 | 12.20 |
| PFX-14-12 | 0.00 | 0.00 | 0.00 |

Thus, methods, systems, devices, compounds and compositions for ANTI-SCALPING PHARMACEUTICAL PACKAGING FILM are described. Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in film manufacturing or related fields are intended to be within the scope of the following claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

What is claimed is:

1. A film for packaging a product comprising nicotine, the film comprising:
a product-contacting sealing layer comprising at least 90 wt. % of a chlorotrifluoroethylene (CTFE)-vinylidene fluoride (VDF) copolymer.

2. A film for packaginga product comprising a pharmaceutical active agent, the film comprising:
a product-contacting sealing layer o prising at least 90 wt. % of a CTFE-VDF copolymer.

3. A film according to claim 2, wherein pharmaceutical active agent is selected from the group consisting of fentanyl, lidocaine, estradiol, clonidine, ethinyl estradiol, oxybutynin, buprenorphine, granisetron, methylphenidate, and scopolamine.

4. A film according to claim 2, wherein the CFTE-VDF copolymer comprises at least 80 mol % chlorotrifluoroethylene units and at least mol % 1-difluoroethylene units.

5. A film according to claim 2, wherein CFTE-VDF copolymer has a glass transition temperature in a range from 40° C. to 70° C.

6. A film according to claim 2, wherein the product-contacting sealing layer comprises at least 95 wt. % of the CTFE-VDF copolymer.

7. A film according to claim 2, wherein the sealing layer consists essentially of the CTFE-VDF copolymer.

8. A film according to claim 2, wherein the product comprising the nicotine or the pharmaceutical active agent comprises a transdermal patch comprising the nicotine or the pharmaceutical active agent.

9. A film according to claim 2, further comprising an exterior protective layer.

10. A film according to claim 9, wherein the exterior protective layer comprises a polymer selected from the group consisting of paper, oriented polyester, amorphous polyester, polyamide, polyolefin, nylon, polypropylene, or copolymers, or blends thereof.

11. A film according to claim 9, further comprising a bulk polyolefin layer between the exterior protective layer and the product-contacting sealing layer.

12. A film according to claim 9, further comprising a metal or metal oxide layer between the exterior protective layer and the product-contacting sealing layer.

13. A film according to claim 2, further comprising an exterior protective layer and an adhesive layer between and in contact with both the product-contacting sealing layer and the exterior protective layer.

14. A film according to claim 2, further comprising an adhesive layer disposed, on the product-contacting sealing layer; a metal or metal oxide layer disposed on the adhesive layer and an exterior protective layer.

15. A film according to claim 14, further comprising a bulk polyolefin layer between the metal or metal oxide layer and the exterior protective layer.

16. A film according to claim 2, wherein the film has a water vapor transmission rate (WTVR) of less than 0.01 g/100 square inches per 24 hours at 23° C. and 1 atmosphere.

17. A packaged pharmaceutical product, comprising:
a film according to claim 2, wherein the a product-contacting sealing layer defines at least a portion of a sealed interior volume; and
the product disposed in the interior volume of the sealed package.

18. A packaged pharmaceutical product, comprising:
a film according to claim 2, wherein the film is formed into a flexible container; and
the product is disposed in the container.

19. (canceled)

20. A method for packaging a pharmaceutical product comprising a pharmaceutical active agent, the method comprising:
sealing the pharmaceutical product in an interior of a packaging film, wherein the film includes a product-contacting sealing layer comprising at least 90 wt. % of a chlorotrifluoroethylene (CTFE)-vinylidene fluoride (VDF) copolymer.

21. A method according to claim 20, wherein the pharmaceutic product comprises a transdermal patch comprising the pharmaceutical active agent.

22. (canceled)

23. (canceled)

24. (canceled)

25. A method according to claim 20, wherein the pharmaceutical active agent comprises nicotine.
